(19) United States
(12) Patent Application Publication
(10) Pub. No.: US 2026/0042231 A1
(43) Pub. Date: Feb. 12, 2026

(54) DEVICE FOR REMOVING ABRASION WEAR-RESISTANT STEEL PLATES

(71) Applicant: TERNIUM MEXICO S.A. de C.V., San Nicolás de los Garza (MX)

(72) Inventors: Efraín Gerardo RODRIGUEZ CHAVARRÍA, Apodaca (MX); Luis Gerardo CÁRDENAS RODRIGUEZ, Apodaca (MX); Milton Alberto PÉREZ MACÍAS, Santiago (MX); Horacio ZAMARRIPA DAVALOS, Monterrey (MX); Yussef NESME MENDOZA, Guadalupe (MX)

(21) Appl. No.: 18/799,744

(22) Filed: Aug. 9, 2024

(51) Int. Cl. B25J 15/06; B25J 19/02; B25J 19/06

(52) U.S. Cl. CPC B25J 15/0608; B25J 19/02; B25J 19/061

(57) ABSTRACT

A device and a method for removing worn or damaged wear-resistant steel plates installed over the surface of substrates subject to wear by contact with abrasive materials, wherein said wear-resistant steel plates are bonded to said substrate by a heat-sensitive adhesive. The device has a frame, one or more electrical resistors to raise the temperature of said wear-resistant steel plates when said frame is positioned above said wear-resistant steel plates, one or more electromagnets being configured and adapted to contact and hold said wear-resistant steel plates when said electromagnets are activated by an electrical current, and one or more handles to separate the device magnetically holding said wear-resistant steel plates away from said substrate. The device may also comprise a thermocouple and a PID controller to control the temperature of the wear-resistant steel plates in a range between 350° C. and 450° C. Optionally, an audible alarm is provided to indicate the operator that the desired temperature has been reached and that separation of the device holding the wear-resistant steel plates away from said substrate can be done. Optionally, the device is split into two separate and independent sections, a first heating section comprising the heating elements to raise the temperature of the wear-resistant steel plates and a second removing section comprising the electromagnets used for engaging and separating the wear-resistant steel plates. Using two separate sections for heating and removing the wear-resistant steel plates provides flexibility regarding the size of the device and allows for removal of wear-resistant steel plates while other wear plates are being heated.

### FIELD OF INVENTION

The present invention relates to a steel cladding system for protection of substrates of steel, aluminum, or other materials subject to abrasive wear, under a cost-effective approach so that said system is easy and simple to install and maintain. The cladding system comprises a plurality of wear-resistant steel plates that are bonded to a substrate by an adhesive. More particularly, the invention relates to a device for efficiently removing from a substrate those wear-resistant steel plates that have been worn or damaged by friction and/or impact of abrasive materials, whereby they will be referred to also as “wear plates” in this document. The device allows a considerable reduction in the time needed for removal of worn or damaged steel plates in operations for transporting abrasive materials, for example, where truck boxes, hoppers and/or train cars are used.

### BACKGROUND OF THE INVENTION

A common operational problem faced in the operation of materials handling equipment such as vehicles for hauling and transportation of abrasive materials in several industrial fields, for example in the mining, steelmaking, agricultural and construction industries, is abrasive wear. To decrease the effects and operational costs of the equipment, it has been proposed to cover the surface of said equipment which is in contact with the abrasive materials with a layer of wear-resistant steel plates which protect the substrate from said abrasion wear. The wear-resistant steel plates lining is installed over the work surface of a variety of substrates, for instance, haul bodies of transport trucks and railroad trains, cement mixers, front loaders, bins, ducts, conveyors or silos for materials handling.

Generally, the steel utilized to manufacture the wear-resistant plates is selected with such characteristics of hardness and mechanical resistance to withstand the stress caused by the weight of load under the harsh working conditions of the substrate; however, the wear-resistant steel plates may be deformed or damaged or their thickness progressively decreases and therefore must be replaced.

Several fastening means can be used for attaching the wear-resistant steel plates to a substrate, for example, bolts, screws, rivets, magnets or an adhesive. The use of bolts, screws or rivets however has the disadvantage of requiring perforations in the plates and substrate entailing sometimes weakening of the substrate and/or tools for installing and removing the wear-resistant steel plates. Use of magnets may in some applications be seen as simpler and effective fastening means but require expensive magnetic materials and strong magnetic fields, consequently, installation and replacement of the wear plates is easier and cost-effective using a kind of adhesive that degrades when heated to a high temperature and its adhesive strength decreases.

The present invention provides a device for removing wear-resistant steel plates, which protects substrates of machinery components and/or materials hauling vehicles, forming a wear liner to replace damaged or worn wear plates.

### OBJECTS OF THE INVENTION

It is therefore an object of the present invention to provide a device for removing from a substrate wear-resistant steel plates wherein said wear-resistant steel plates are bonded to said substrate by a heat-sensitive adhesive, whose adhesive strength decreases above a certain temperature.

It is another object of the invention to provide a method for removing wear-resistant steel plates installed over the surface of substrates subject to wear by contact with abrasive materials, wherein said wear-resistant steel plates are bonded to said substrate by a heat-sensitive adhesive whose adhesive strength decreases above a certain temperature.

Other objects of the invention are herein pointed out or will be evident from the description thereof.

### SUMMARY OF THE INVENTION

The objects of the invention are generally achieved by providing a device for removing wear-resistant steel plates installed over the surface of substrates subject to wear by contact with abrasive materials, wherein said the wear-resistant steel plates are bonded to said substrate by a heat-sensitive adhesive, comprising a frame, one or more electrical resistors attached to said frame to raise the temperature of said the wear-resistant steel plates when said frame is positioned above said wear-resistant steel plates, one or more electromagnets attached to said frame being configured to contact and hold said wear plates when said electromagnets are activated by an electrical current, and one or more handles to separate away from said substrate, the device magnetically holding said the wear-resistant steel plates.

Another object of the invention is achieved by providing a method for removing the wear-resistant steel plates installed over the surface of substrates subject to wear by contact with abrasive materials, wherein said wear-resistant steel plates are bonded to said substrate by a heat-sensitive adhesive, which comprises the steps: positioning above said wear-resistant steel plates a device having one or more electrical resistors and one or more electromagnets attached to said frame, passing an electrical current through said resistors to raise the temperature of said wear-resistant steel plates above a predetermined temperature so that the adhesive strength between said wear plates and said substrate decreases, passing electrical current through said one or more electromagnets to contact and hold said wear-resistant steel plates by magnetic force, and separating away from said substrates the device magnetically holding said wear-resistant steel plates.

### BRIEF DESCRIPTION OF THE DRAWINGS

FIG. 1 shows a schematic plant view of an embodiment of the invention as seen when the wear-resistant steel plates remover device is positioned above the wear plates.

FIG. 2 shows a schematic lateral view of the device in the position shown in FIG. 1.

FIG. 3 shows a schematic lateral view of the device as indicated in FIG. 1.

FIG. 4 shows a schematic cut view A-A during the time when the electromagnetic elements that hold the plate to be removed have not yet engaged said plate.

FIG. 5 shows a schematic cut view A-A during the time when the electromagnetic elements that hold the plate to be removed have engaged said plate.

FIG. 6 shows a perspective view of the device seen from the upper side opposite to the side facing the plate to be removed.

FIG. 7 shows a perspective view of the device seen from the lower side facing the plate to be removed.

FIG. 8 shows a diagram of an embodiment of the invention where the device is formed of a plurality of interlinked sections so that the heating elements can be closer to the plates in curved or angled surfaces.

FIG. 9 shows a diagram of an embodiment of the invention where the device is split into two separate sections, a heating section and a removing section whereby the plates may be heated while other plates already heated are removed saving operational time.

### DETAILED DESCRIPTION OF PREFERRED EMBODIMENTS

The present invention will be better understood with reference to detailed description of certain specific non-limiting embodiments thereof.

The following description is done in general as referred to a device for removing wear-resistant steel plates from a substrate, for example, from a haul body of trucks, dump trucks for transporting materials and from a cement-mixer truck, but it will be understood that the invention can be adapted to other applications such as to railroad cars, bins, ducts, silos, components of mining and construction machinery and in general equipment for materials handling.

To facilitate reading the description of the invention, same numerals are intended to designate same elements of the device illustrated in the attached figures.

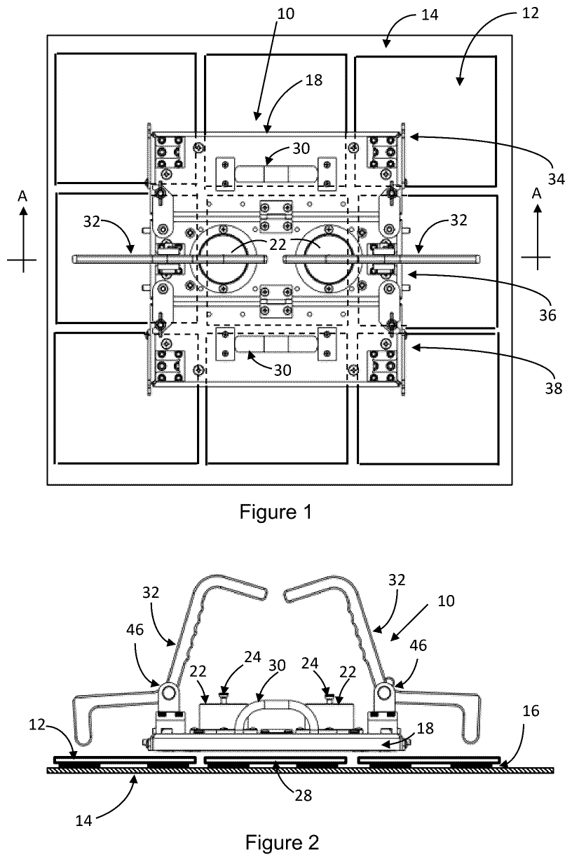

Referring to the attached figures, and in particular FIG. 1, numeral 10 generally designates a device for removing worn or damaged wear plates 12 which are attached to a substrate 14 by means of an adhesive 16 (shown in FIG. 2). When the wear level of the wear plates 12 reaches a predetermined value, which can be determined, for example, visually or periodically measuring the thickness of the plates, or also by means of ultrasound, the wear plates are replaced with new ones.

In some embodiments of the invention, the wear plates 12 have a major dimension between 100 mm and 600 mm, a thickness between 2 mm and 4 mm and are replaced when its thickness in any area of said plate is less than 1 mm.

Referring to FIGS. 1 and 2, in some embodiments, the device 10 comprises a frame 18, where two electromagnets 20 are movably attached thereto within a housing 22 and suspended inside by means of a guide bar 24 and held by spring 26, shown in FIG. 4 in a normal deactivated position where there is no contact of said electromagnets with the plate to be removed to avoid damage by contact of said electromagnets 20 with the wear-resistant steel plate to be removed 28 at high temperature. When an electric current passes through the electromagnets 20 from an electric power source and through a suitable connection cable, not shown for simplicity of the figures, the electromagnets 20 are activated and the resulting magnetic attraction force moves the electromagnets 20 to contact the wear plate to be removed 28, as shown in FIG. 5, firmly engaging said plate with sufficient force so as to be separated from substrate 14 when the device 10 is moved away of said substrate 14 using handles 30 or levers 32. The engaging force of each of the electromagnets 20 and the wear plate 28 is preferably in the range between 15 Kg and 25 Kg. It will be evident that the engaging force of the electromagnets can be adjusted, without departing from the scope of the invention, according to the adhesive strength of the adhesive material at the temperature level that the wear plate 28 is heated.

Referring to FIG. 4, and 5, in some embodiments, the electromagnets 20 move inside their housings 22 suspended by guide bars 24 which move loosely under the action of springs 26 and electromagnetic force. Guide bars 24 are configured to be moved away from substrate 14 along with device 10, for example, by providing said guide bars with an expanded end portion at the end outside housings 22 dimensioned to not pass through the orifice in housings 22, but other engaging structures can be used. The electromagnets 20 are movably attached to a housing and suspended inside said housing normally separated from the wear-resistant steel plate to be removed so that said electromagnets are not damaged by extended contact with the plate to be removed at high temperature.

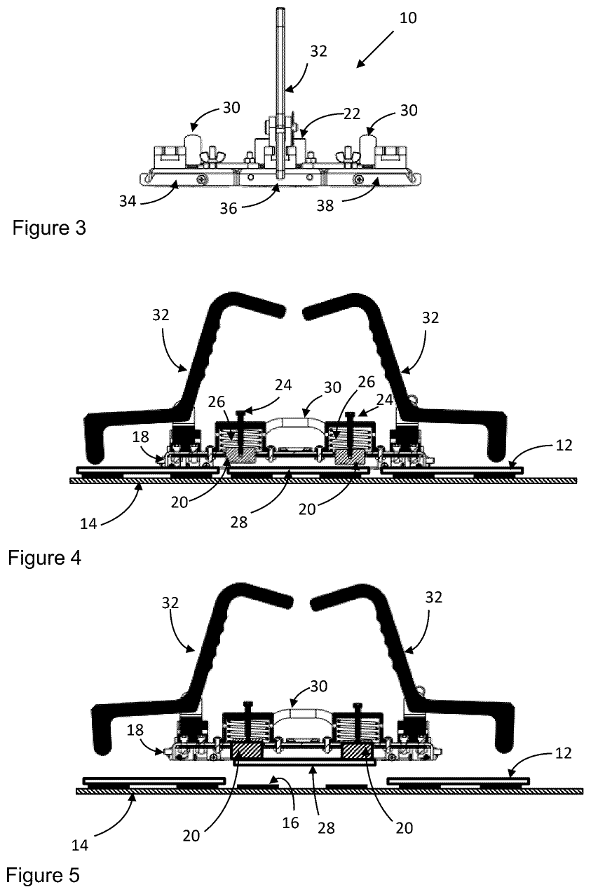

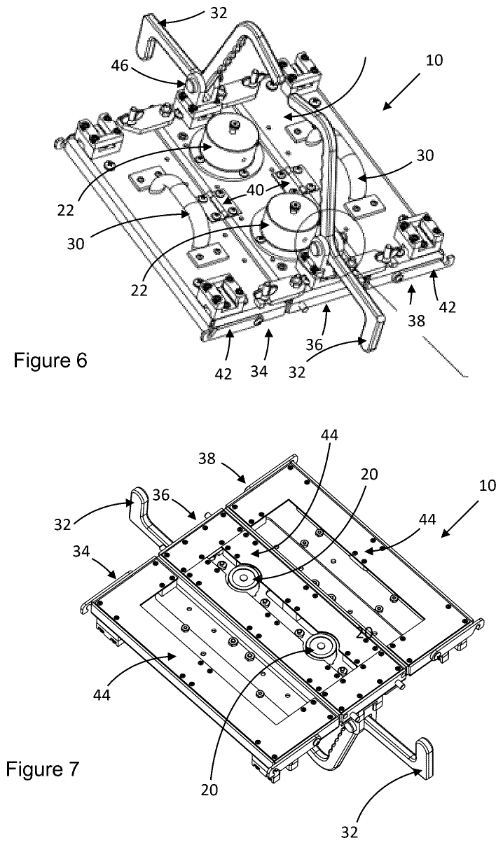

Referring to FIGS. 3 to 6, in some embodiments, frame 12 comprises three segments 34, 36 and 38, so that the device 10 may be configured to cover wear-resistant steel plates to be removed of different sizes. Segments 34 and 38 are joined to segment 36, for example, by means of hinges 40 and can be locked in their extended position by means of locking elements 42. The device can be made of anodized aluminum sheet, or any other metallic material, covering an area, for example, of 30 cm×30 cm, when all three segments are in the working position, and an area, for example, of 30 cm×20 cm, when segments 34 and 38 are folded and only segment 36 is used. Such configurations are achieved by adjusting several steel locks 42 on the device to ensure the desired arrangement and its stability. The dimensions of device 10 can be modified to fit the average size of the wear plates that will be removed from a substrate.

In some embodiments, the levers 32 are preferably configured to allow the operator to use said levers 32 as holders of the device when the segments 34 and 38 are folded and consequently the handles 30 cannot be used. Levers 32 are also preferably configured to pivot on intermediate supports 46 to facilitate the operator separation of the wear plate to be removed.

Referring to FIG. 7, in some embodiments, device 10 is provided with electrical resistors 44, to raise the temperature of the wear plate to be removed 28 by heat transfer and the Joule effect. These resistors 44 are independent, which allows them to be activated in the appropriate configuration to heat the periphery of the wear plate to be removed. These resistors have the capacity to heat above 350° C., necessary to degrade the adhesive and decrease the adhesive strength between the wear plate 28 and substrate 14, with a power of 500 W and a voltage of 24V. Resistors 44 are shielded by a layer of insulating material, such as fiberglass on the side contacting the frame to avoid heat transfer to said frame to ensure a safe operation of the remover device 10.

The resistors 44 are independent with respect to their operation and can be activated in the configuration that may best fit the heating of the periphery of the wear-resistant steel plate to be removed 28.

In some embodiments, for a safe operation of device 10 and avoid overheating, a thermocouple (not shown) can be provided attached to said frame 18 to monitor the temperature of wear-resistant steel plates, for example, at a location near the point of contact of a resistor 44 with the wear plate 28. A control signal emitted by the thermocouple can then be used by a PID controller (Proportional, integral and derivative controller) (not shown) which can control the electric current passing through said resistor 44 and maintaining the temperature within a predetermined range. Also, an audible alarm can be provided, to indicate to the operator that the desired temperature has been reached and that separation of the wear plates to be removed can be done.

Device 10 adapts to any shape and size of wear-resistant steel plates 12 used to properly cover the surface of the protected substrate.

In some embodiments, the adhesive to be used is mono-component based on modified silane polymers having an elongation at break (ISO 37 at a velocity of 200 mm/min) between 230% and 260% and a tensile strength at 100% elongation (ISO 37) between 1.1 MPa and 1.5 MPa, or similar characteristics. This type of adhesive provides an adequate bonding force so that the wear-resistant steel plates are not detached from the surface to be protected and presents sufficient fatigue resistance that may be caused by the relative movement between such wear-resistant steel plates and the protected surface. The adhesive strength of an adhesive of the above-mentioned type weakens when its temperature is above 350° C.

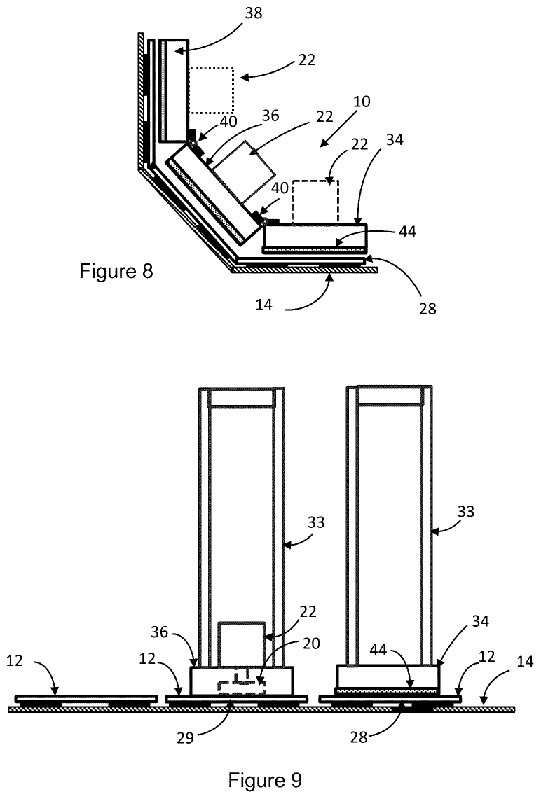

Referring to FIG. 8, in some embodiments the hinges 40 of device 10 and sections 34, 36 and 38 are configured to allow the device to bend and conform to arcuate or angled surfaces, for example at corners of substrates such as truck boxes, or railroad cars. In this case, sections 34, 36 and 38 may have shorter dimensions so that the heating elements 44 can be positioned close to wear-resistant steel plates to be removed 28. Electromagnets may be installed only in central section 36 or in each of sections 34, 36 and 38 as necessary for removing arcuate or angled wear-resistant steel plates 28.

Referring to FIG. 9, in some embodiments, device 10 is split into at least two separate and independent sections 34 and 36. A first heating section 34 comprising heating elements, such as electrical resistors 44 to raise the temperature of the wear-resistant steel plates 28 and a second removing section 36 comprising at least one electromagnet 20 within cover 22 used for engaging and separating the already heated wear-resistant steel plates. Removal of wear-resistant steel plates is then carried out positioning the first heating section 34 over the plates to be removed 28 and when the temperature of said wear plates is within 350° C. and 450° C., the first heating section 34 is moved away and the second removing section comprising the electromagnets 20 is positioned over and contacting the plates 28 to engage them. Wear plates 28 are then removed by pulling the removing section 36 using handle 33.

The embodiments comprising two separate sections for heating and removing the wear-resistant steel plates provide flexibility regarding the size of the device where the heating elements are installed and also contribute to saving operational time because removal of wear-resistant steel plates may be carried out while other wear-resistant steel plates are being heated.

Another aspect of the invention refers to a method for removing wear-resistant steel plates installed over the surface of substrates subject to wear by contact with abrasive materials, wherein said wear-resistant steel plates are bonded to said substrate by a heat-sensitive adhesive, which method comprises: positioning above said wear-resistant steel plates a device having one or more heating elements, such as electrical resistors to raise the temperature of said wear-resistant steel plates between 350° C. and 450° C. so that the adhesive bonding force between the wear-resistant steel plates and said substrate decreases, passing electrical current through one or more electromagnets attached to said frame to contact and hold said wear plates by magnetic force, and separating the device magnetically holding said wear plates from said substrate.

It is understood that the expressions “one embodiment”, “some embodiments” and similar wording do not refer necessarily to the same embodiment and that the feature of the invention referred to in this description may be combined in one or more embodiments of the invention. Also, it is understood that the above description of some embodiments of the invention is intended to be illustrative only and that changes may be made in the structure of the device, or the method described and its operating conditions without departing from the spirit and scope of the invention defined in the attached claims.

What is claimed is:

1. A device for removing wear-resistant steel plates installed over the surface of substrates subject to wear by contact with abrasive materials, wherein said wear-resistant steel plates are bonded to said substrate by a heat-sensitive adhesive, comprising: a frame, one or more electrical resistors to raise the temperature of said wear-resistant steel plates when said frame is positioned above said wear-resistant steel plates, one or more electromagnets attached to said frame, said one or more electromagnets being configured and adapted to contact and hold said wear-resistant steel plates when said electromagnets are activated by an electrical current, and one or more handles to separate away from said substrate the device by magnetically holding said wear-resistant steel plates.

2. A device for removing wear-resistant steel plates according to claim 1 wherein said frame comprises a plurality of segments joined by hinges and locking elements among themselves configured to allow said segments to fold and so to cover different areas when all segments are in the working position, and smaller areas, when some segments are folded, to fit the average size of the wear-resistant steel plates that will be removed from said substrate.

3. A device for removing wear-resistant steel plates according to claim 1 wherein said device comprises at least two separate and independent sections, a first heating section comprising heating elements, to raise the temperature of the wear-resistant steel plates to be removed and a second removing section comprising at least one electromagnet for engaging and separating heated wear-resistant steel plates.

4. A device for removing wear-resistant steel plates according to claim 1, wherein said electromagnets are movably attached to a housing and suspended inside said housing by means of a guide bar and a spring which in a normal deactivated position maintains the electromagnets separated from the wear-resistant steel plate to be removed so that said electromagnets are not damaged by extended contact with the plate to be removed at high temperature.

5. A device for removing wear-resistant steel plates according to claim 1, wherein said resistors have the capacity to heat said wear-resistant steel plates above 350° C.

6. A device for removing wear-resistant steel plates according to claim 1, wherein said resistors operate with a power of 500 W and a voltage of 24V.

7. A device for removing wear-resistant steel plates according to claim 1, further comprising a thermocouple attached to said frame to monitor the temperature of said wear-resistant steel plates.

8. A device for removing wear-resistant steel plates according to claim 6, further comprising a PID controller adapted to receive a control signal from said thermocouple and to control the electric current passing through said resistors to maintain the temperature of said wear-resistant steel plates within a predetermined range.

9. A device for removing wear-resistant steel plates according to claim 7, wherein said temperature of the wear-resistant steel plates is controlled to be in the range between 350° C. and 450° C.

10. A device for removing wear-resistant steel plates according to claim 7, further comprising an audible alarm actuated by said PID controller to indicate that the desired temperature has been reached and that separation of the wear-resistant steel plates to be removed can be done.

11. A method for removing wear-resistant steel plates installed over the surface of substrates subject to wear by contact with abrasive materials, wherein said wear-resistant steel plates are bonded to said substrate by a heat-sensitive adhesive, which comprises the steps: positioning above said wear-resistant steel plates a device having one or more electrical resistors and one or more electromagnets attached to said frame, passing an electrical current through said resistors to raise the temperature of said wear-resistant steel plates within 350° C. and 450° C. so that the adhesive strength between said wear-resistant steel plates and said substrate decreases, passing electrical current through said one or more electromagnets to contact and hold said wear-resistant steel plates by magnetic force, and separating away from said substrates the device magnetically holding said wear-resistant steel plates.

12. A method for removing wear-resistant steel plates according to claim 11, wherein said device comprises at least two separate and independent sections, a first heating section comprising heating elements, to raise the temperature of the wear-resistant steel plates to be removed and a second removing section comprising at least one electromagnet for engaging and separating heated wear-resistant steel plates further said method further comprising positioning the first heating section over the plates to be removed and when the temperature of said wear-resistant steel plates is within 350° C. 450° C, moving away the first heating section and thereafter positioning the second removing section over and contacting the heated wear-resistant steel plates and removing said wear-resistant steel plates away of said substrate.

13. A method for removing wear-resistant steel plates away from a substrate according to claims 11 and 12, further comprising producing an audible alarm when the temperature of said wear-resistant steel plates is above 350° C.

14. A method for removing wear-resistant steel plates away from a substrate according to claims 11 and 12, further comprising allowing said electromagnets to move by means of a guide bar and a spring at a normal deactivated position where the electromagnets are separated from the wear-resistant steel plates to be removed so that said electromagnets are not damaged by extended contact with the plate to be removed at high temperature.
